(19) United States
(12) Patent Application Publication
(10) Pub. No.: US 2014/0029558 A1
(43) Pub. Date: Jan. 30, 2014

(54) Uplink Control Signalling in a Carrier Aggregation System

(71) Applicants: Frank Frederiksen, Klarup (DK); Troels Emil Kolding, Klarup (DK); Istvan Zsolt Kovacs, Aalborg (DK); Klaus Ingemann Pedersen, Aalborg (DK); Claudio Rosa, Randers (DK)

(72) Inventors: Frank Frederiksen, Klarup (DK); Troels Emil Kolding, Klarup (DK); Istvan Zsolt Kovacs, Aalborg (DK); Klaus Ingemann Pedersen, Aalborg (DK); Claudio Rosa, Randers (DK)

(73) Assignee: Nokia Siemens Networks Oy, Espoo (FI)

(21) Appl. No.: 14/110,472

(22) PCT Filed: Apr. 8, 2011
(86) PCT No.: PCT/EP2011/055474

§ 371 Date: Oct. 8, 2013

(51) Int. Cl. H04W 72/04

(52) U.S. Cl. CPC H04W 72/0413
USPC 370/329

(57) ABSTRACT

An apparatus is described which includes a transceiver configured to be connectable to a first network node by a first uplink connection and at least a second network node by a second uplink connection. Uplink control signalling is generated independently for each network node, wherein the generated uplink control signalling for the first network node is sent via the first uplink connection, and the generated uplink control signalling for the second network node is sent via the second uplink connection.

### FIELD OF THE INVENTION

The present invention relates to apparatuses, methods and a computer program product for sending uplink control signalling in case of a multi-node carrier aggregation transmission scheme.

### RELATED BACKGROUND ART

The following meanings for the abbreviations used in this specification apply:
AMC Adaptive modulation & coding
A/N Ack/Nack (Acknowledgement/Non-Acknowledgement)
CA Carrier aggregation
CC Component carrier
C-plane Control plane
CQI Channel quality indicator
DC Dual carrier
DCI Downlink control information
DL Downlink
eICIC Enhanced inter-cell interference coordination
eNB enhanced Node-B
HARQ Hybrid automatic repeat request
HeNB Home enhanced Node-B
HetNet Heterogeneous networks
HO Handover
HSDPA High speed downlink packet access
L1 Layer 1
L2 Layer 2
LTE Long term evolution
LTE-A LTE-Advanced
MAC Media access control
MUX Multiplex
PCell Primary cell
PDCCH Physical downlink control channel
PRB Physical resource block
PUCCH Physical uplink control channel
PUSCH Physical uplink shared channel
RF Radio frequency
RLC Radio link control
RNC Radio network controller
RRM Radio resource management
SCell Secondary cell
SR Scheduling request
UCI Uplink control information
UE User equipment
UL Uplink
U-plane User plane
WCDMA Wideband code division multiple access

Embodiments of the present invention relate to carrier aggregation (CA), as introduced in Rel-10 of the E-UTRA specifications. By means of carrier aggregation (CA), two or more component carriers (CCs) are aggregated in order to support wider transmission bandwidths up to 100 MHz. In CA it is possible to configure a UE to aggregate a different number of CCs originating from the same eNB and of possibly different bandwidths in the uplink (UL) and downlink (DL). In addition, configured CCs can be deactivated in order to reduce the UE power consumption: the UE monitoring activity of a de-activated carrier is reduced (e.g. no PDCCH monitoring and CQI measurements).

This mechanism is referred to as carrier activation/deactivation.

Furthermore, a deployment of low-power eNBs in areas with already existing macro cell coverage yields cellular systems with overlapping layers of macro cells and smaller cells (e.g. pico cells). These types of network deployments are also known as heterogeneous networks. In the latest years heterogeneous networks have become topic of research activities and extensive work in standardization bodies. One of the most critical and challenging tasks in heterogeneous networks is efficient support of mobility. Also, traffic steering between macro and pico layers also becomes an important task for network operators.

### SUMMARY OF THE INVENTION

Embodiments of the present invention aim to provide efficient support of mobility in case of heterogeneous networks.

According to a first aspect of the present invention, this is accomplished by a an apparatus comprising a transceiver configured to be connectable to a first network node by a first uplink connection and at least a second network node by a second uplink connection. Uplink control signalling is generated independently for each network node, wherein the generated uplink control signalling for the first network node is sent via the first uplink connection, and the generated uplink control signalling for the second network node is sent via the second uplink connection.

According to a further aspect, an apparatus is provided which comprises a transceiver configured to be connectable to a user equipment an uplink connection and to be connectable to a another network node via an interface, the other network node being connectable to the same user equipment, wherein uplink control signalling dedicated for the apparatus is received via the uplink connection from the user equipment independently from the other network node.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 shows an example for heterogeneous network scenario in which a macro-eNB and a plurality of pico-eNBs are provided within the coverage area of the macro-eNB,

FIG. 2A illustrates sending of UCI to a PCell only, and FIG. 2B illustrates an operation according to an embodiment of the invention, and

FIG. 3 shows an UE, a macro node and a pico node according to an embodiment of the present invention.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

According to several embodiments, it is aimed to provide efficient support of mobility for heterogeneous networks.

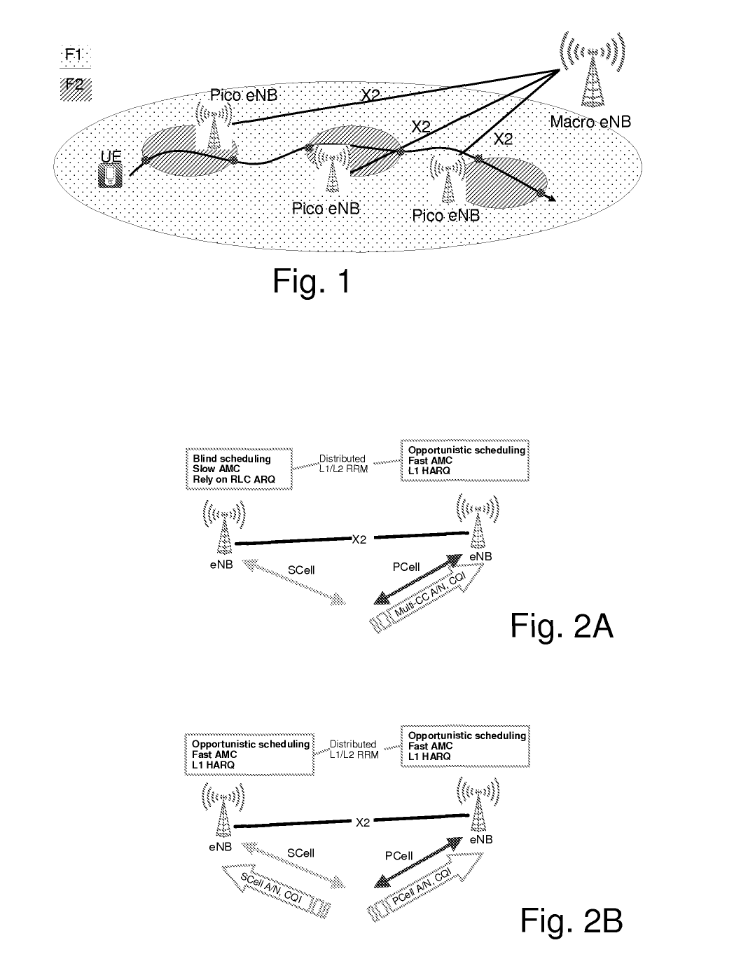

In practice, inter-site CA means that the PCell and SCell are transmitted from/received to non-co-sited access nodes. While enabling fast and seamless handover (see FIG. 1) and/or traffic steering/offloading between macro-node and pico-nodes, inter-site CA also introduces important challenges to radio resource management (RRM). The problem is that in Rel-10 CA framework layer 1 (L1) UL feedback information is typically conveyed from the UE using the PCell, i.e., is sent to the macro node. This means that a high-capacity low-latency low-jitter (fiber) connection between access nodes is needed in order to support “centralized” opportunistic scheduling, adaptive modulation & coding (AMC), HARQ, etc.

Such a centralized approach is however disadvantageous with respect to the very high capacity connection requirements between the different nodes (e.g., macro eNB (PCell) and pico eNB (SCell)).

In particular, in such a central approach a unit would control the scheduling on both non-co-sited CCs (i.e., the connection between the UE and the macro eNB and the connection between the UE and the pico eNB). This (proprietary) solution, however, would require high-capacity low-latency low-jitter (fiber) connection between nodes, so that the scheduling information available at one access node can be (almost) instantaneously made available at the non-co-sited access node.

According to embodiments of the present invention, fundamental L1/L2 RRM functionalities as described above are done independently per CC. This introduces a number of challenges on how L1 UL feedback information should be separately conveyed from the UE to the non-co-sited cells. The problem whose solution is addressed by embodiments of the present invention is illustrated in FIGS. 2A and 2B.

In particular, FIGS. 2A and 2B show a situation in which a user equipment (UE) is connected to two eNBs via PCell (i.e., to a macro-node) and SCell (i.e., to a pico-node), wherein both nodes are connected to each other via an X2 interface.

FIG. 2A shows the problem when using the centralized approach as described above, i.e., the LTE Rel-10 UCI framework. In this case, UCI (including Multi-CC A/N, CQI etc.) is sent only on the PCell, i.e., only to the macro node. The SCell, i.e., the pico-node receives necessary control signaling from the macro-node via the X2 interface. That is, only for the macro-node opportunistic scheduling, fast AMC and L1 HARQ are possible, whereas for the pico-node only blind scheduling and slow AMC is possible, and it has to rely on RLC ARQ only.

FIG. 2B shows illustrates the solution according to embodiments of the invention. In particular, on the PCell a UCI is transmitted, and also on the SCell a UCI is transmitted separately. That is, the UCI on the PCell may contain a PCell A/N, a CQI etc., and independent therefrom, the UCI on the SCell may contain a SCell A/N, a CQI etc. In this way, opportunistic scheduling, fast AMC and L1 HARQ are possible for both nodes.

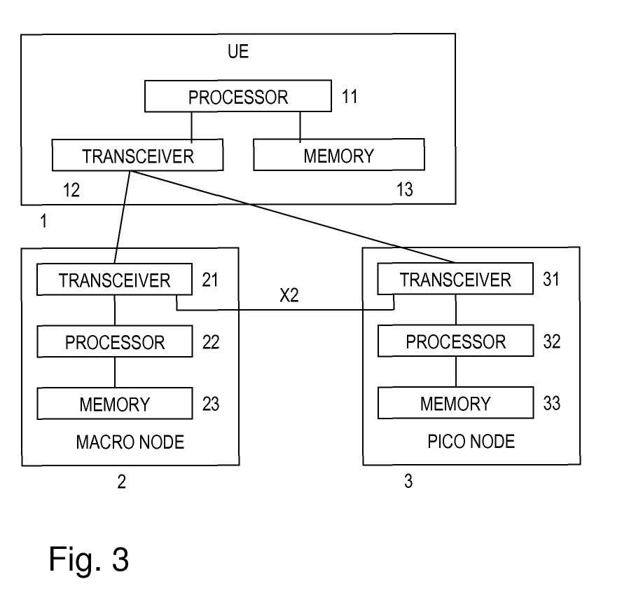

In the following, network elements according to embodiments of the present invention are described by referring to FIG. 3. A user equipment 1 may comprise a processor 11, a transceiver 12 and a memory 13. A macro node 2 (as an example for a first network node) may comprise a processor 21, a transceiver 22 and a memory 23, and a pico node 3 (as an example for a second network node) may comprise a processor 31, a transceiver 32 and a memory 33. The memories 13, 23 and 33 may store programs, by means of which the processors 11, 21 and 31 may carry out their corresponding functions.

The two nodes 2 and 3 are connected to each other via an X2 interface. A connection between the UE 1 and the macro node 2 is referred to as a first uplink connection, and a connection between the UE 2 and the pico node is referred to as a second uplink connection.

The processor of the UE 1 generates uplink signalling (e.g., UCI), and the transceiver 12 sends the uplink control signalling (e.g., UCI) for the first network node via the first uplink connection, and the uplink control signalling (e.g., UCI) for the second network node via the second uplink connection.

In this way, the uplink control signalling is sent independently to each network node on separate uplink connections.

According to more detailed embodiments of the present invention, in order to support independent per-CC RRM with inter-site CA (non-co-sited CCs), the idea of separate uplink control signaling on a CC basis is introduced. Independent UCI per CC requires separate uplinks to convey UCI via specific CC (i.e. UCI for PCell transmitted via PCell, and UCI for SCell transmitted via SCell). Therefore, the working assumption is that terminals support multi-band (CC) transmission in UL and reception in DL and not necessarily the same number of UL and DL CCs are used.

The “SCell” in the description below refers to the non-co-sited SCell or group of non-co-sited SCells. That is, the invention is not limited to a single SCell or pico node (or second node as described in the above general embodiment), but a plurality of SCells or pico nodes can be used.

In the following, some more details of the embodiments are described.

As mentioned above, according to the embodiment, separate and independent UIC per CC are introduced.

For this, separate PUCCH may be configured on PCell and SCell, via which the both UIC may be sent to the corresponding nodes.

Alternatively, there is the possibility to transmit UCI on PUSCH separately on PCell and SCell (if PUSCH resources are simultaneously scheduled on PCell and SCell).

It is also possible to transmit UCI on PUSCH on SCell (PCell) and UCI on PUCCH on PCell (SCell) if PUSCH is only allocated on one CC. That is, UCI for PCell is transmitted via PUSCH on PCell, while UCI for SCell is transmitted via PUCCH on SCell or vice versa.

In this connection it is noted that PUSCH transmission typically imposes looser UE RF requirements compared to PUCCH since:

(1) PUCCH typically occupies a lower number of PRBs, and

(2) PUCCH is typically closer to the edge of the allocated spectrum, and therefore requires more power backoff compared to an equivalent allocation in the centre of the available spectrum.

Therefore, according to the present embodiments of the invention, also solutions are proposed for the case where dual-UL PUCCH transmission requires excessive power backoff at the UE:

A first solution is to introduce new special DCI formats to allocate A/N resources (in a similar way as the special DCI format was introduced for scheduled CQI) in case simultaneous PUCCH on PCell and SCell is causing excessive power backoff in the UE. An example for such a new DCI format introduced for scheduled DCI could be: redefining the meaning of certain bits in the DCI to indicate fixed allocation of one PRB and a cyclic shift to be used by each UE when reporting the A/N.

Alternatively, PCell could stop scheduling UE if it estimates that dual-UL transmission is requiring too much power backoff.

Another alternative solution is that the UE only reports UL feedback on one CC (selected by UE or based on priority order decided by the network) if the UE estimates that dual-UL transmission would require too much power-backoff.

Hence, considering the power requirements for the UE, sending of the uplink control signaling (UCI) on both connections may also be limited, if necessary.

In the following, handling of a scheduling request (SR) as a specific example of UCI on PUCCH is described in more detail.

There are several possibilities to transmit an SR.

As a first possibility, the SR may be transmitted on both PUCCH (received at both PCell and SCell)

In this way, it is possible to allow allow dual-UL PUSCH. Minimize latency since both PCell and SCell can start scheduling at first SR occurrence. It is noted that Dual-UL PUSCH increases the peak data rate but in some cases might have the disadvantage of requiring excessive power-backoff at the UE. However, in this case the node hosting the PCell has still the possibility to ignore the SR and start monitoring UL data transmission via SCell, power headroom reports etc. Only after that it could decide to start scheduling PUSCH on PCell.

Moreover, SR transmission on both PCell and SCell might have some impact on UE RF requirements if SR transmission is simultaneous.

Therefore, another possibility is to transmit the SR only on one of the serving cells (i.e., PCell (macro node) or SCell (pico node)).

For example, this serving cell can be fixed configured by network. That is, the network can configure that in such a case, always the SR is to be transmitted to the macro node, for example.

In this way, simultaneous SR on PCell and SCell is avoided. However, this does not result to an enhanced uplink data rate for a UE approaching a pico-cell if the SR is only transmitted via PUCCH on PCell (=macro-cell)—unless SR is forwarded to node hosting SCell via X2.

The above-described serving cell can also be selected by UE based on path loss measurement.

In this way, simultaneous SR on PCell and SCell is avoided. PUSCH resources are “automatically” scheduled on the best serving cells with no need for exchanging information over X2.

However, if SR is sent on SCell, dual-uplink PUSCH is still possible as soon as the access node hosting the PCell “detects” UL transmission from specific UE (with some delay). If SR is sent on PCell then dual-UL PUSCH is not possible—unless PCell instructs SCell to start scheduling UL resources on PUSCH.

Further alternatively, the above one of the serving cell may be the serving cell with earliest SR occurrence. The SR could be sent by the UE on PCell or SCell depending on which cell the SR can transmitted first. The timing of SR is determined by PHY parameters and it can be different for the PCell and SCell carriers. A use case for this is when latency of the requested UL scheduling grant is critical.

In this way, also simultaneous SR on PCell and SCell can be avoided. Moreover, latency can be minimized.

However, no enhanced uplink data rate for a UE approaching a pico-cell (=SCell) if the serving cell with earliest SR occurrence is the PCell (=macro-cell), unless the SR is forwarded to node hosting SCell via X2.

Thus, preferably also the scheduling request (SR) should be sent on both uplink connections. However, if due to power requirements or UE RF requirements it is necessary to sent the SR only on one uplink connection, it can then be decided based on the considerations above which alternative is suitable for the situation.

Hence, the proposed solutions according to the detailed embodiments described above provide the UL control signaling framework to support inter-site LTE CA with independent per-CC L1/L2 radio resource management

Therefore, the proposed solution still allows for gains from fast L1/L2 radio resource management: opportunistic scheduling, L1 HARQ, fast AMC, etc.

Moreover, the baseline Rel-10 UL physical channel structure can be maintained, so that the proposed solutions can easily be implemented.

In addition, aggregation of non-co-located LTE carriers is also possible with high-latency connection (X2) between access nodes.

Besides this, the main advantages of supporting aggregation of non-co-located LTE carriers are:

It is possible to enhance mobility support in heterogeneous networks scenarios. That is, signaling overhead associated with HO procedure can be reduced when a mobile terminal moves around a macro-cell area with several pi-co-nodes deployed. Without the proposed solutions the UE needs to perform a HO every time it enters/exits the coverage area of a pico-cell. While the “cost” of a HO procedure is probably comparable to that of configuring a new SCell (=pico-cell), the proposed solutions significantly reduces the signaling overhead when e.g. the UE exits the pico-cell coverage area, and should be handed back to the macro-node. Moreover, the proposed solutions also improve mobility robustness in high mobility scenarios since the link in target cell can be “warmed up” before the HO actually taking place.

Furthermore, dynamic traffic steering/offloading is possible. That is, with an inter-site CA network operators have the possibility to more dynamically steer/offload data traffic from macro-cellular to pico-cellular layer (and vice versa). The actual gain of fast & dynamic traffic steering/offloading using inter-site CA compared to traditional HO needs to be carefully assessed taking into account UE power consumption, impact on signaling load on core and/or X2, etc.

In addition, data rate boost can be achieved. UE is in coverage region of both pico and macro where these nodes using different frequencies. Thus, by allowing the UE to be served on both cells, the available bandwidth gets larger, resulting in higher data.

In the following, some more implementation details for the solutions as described above are given.

Both CCs (PCell and SCell) may use LTE technology and are deployed in different frequency bands.

Radio resources on SCell may be allocated via PDCCH on SCell, i.e. no cross-CC scheduling is applied. In this way scheduling on SCell can be performed at the node controlling it.

UCI (A/N, CQI, etc.) for the DL SCell may be conveyed to the access node via corresponding UL SCell. Transmission of UCI on SCell happens as if SCell was the only configured CC. This would be a similar behavior as with Rel-8/Rel-10 UEs with only one CC (PCell) configured.

Cases where dual-uplink UCI transmission causes excessive power-backoff at the UE may be detected and handled at the node controlling the PCell.

The proposed solutions are mainly described in connection with the case of LTE carriers in different frequency bands. However, the solutions can easily be applied to a case where component carriers are in the same frequency bands, as well a to the case where different radio access technologies are used on different component carriers.

It is noted that in the above detailed embodiments, the first and the second uplink connections between UE and the two network nodes (macro and pico node) are realized via one CC, respectively. However, the number of CCs is not limited, and each connection can be realized also via two or more CCs, and the number of CCs may vary between the two connections. Moreover, the number of CCs does not have to be the same for uplink and downlink.

Moreover, in the above detailed embodiments a case was described that the primary cell is served by a macro node (macro-eNB), i.e., the base station which controls the larger cell. However, the invention is not limited to this, and it is possible that also a pico node (pico-eNB), i.e., a base station which controls the smaller cell, functions as a primary cell, whereas the macro node functions as a secondary cell.

Furthermore, both network nodes (base stations) could be equal. For example, two eNBs could work together in an overlapping area of the cells, in which the UE is located. That is, one the eNBs would then be the primary cell, and the other eNB would be the secondary cell.

Moreover, the nodes described above as eNBs and/or macro and pico nodes or eNBs are not limited to these specific examples and can be any kind network node (e.g., a base station) which is capable for transmitting via component carriers to a user equipment.

According to a first aspect of general embodiments of the present invention, an apparatus is provided comprising
a transceiver configured to be connectable to a first network node by a first uplink connection and at least a second network node by a second uplink connection,
a processor configured to generate uplink control signalling independently for each network node,
wherein the transceiver is configured to send the generated uplink control signalling for the first network node via the first uplink connection, and the generated uplink control signalling for the second network node via the second uplink connection.

The first aspect may be modified as follows:

The first uplink connection may comprise at least one component carrier, and the second uplink connection may comprise at least one component carrier.

On the first uplink connection a physical uplink control channel may be configured and on the second uplink connection a physical uplink control channel may be configured, and the transceiver may be configured to send the generated uplink control signalling via the physical uplink control channels on the first and the second uplink connections, or

on the first uplink connection a physical uplink shared channel may be configured and on the second uplink connection a physical shared control channel may be configured, and the transceiver may be configured to send the generated uplink control signalling via the physical shared control channels on the first and the second uplink connections.

A physical uplink shared channel may be configured on one of the first and second uplink connections, and a physical uplink control channel may be configured on the other one of the first and second uplink connections, and the transceiver may be configured to send the generated uplink control signalling via the physical uplink shared channel on the corresponding one of the first and second uplink connections and the physical uplink shared channel on the corresponding other one of the first and second uplink connection.

That is, for example in terms of the embodiment described in connection with FIG. 2B, UCI (as an example for uplink control signaling) for PCell (as an example for the first network node) is transmitted via PUSCH on PCell (i.e., via PUSCH on the first uplink connection), while UCI for SCell (as an example for the second network node) is transmitted via PUCCH on SCell (i.e., via PUCCH on the second uplink connection).

The processor may be configured to decide sending the uplink control signalling only on one of the first uplink connection and the second uplink connection.

The processor may be configured to base the decision on power requirements of the apparatus.

The uplink control signalling may comprise a scheduling request, and the processor may be configured to send the scheduling request on physical uplink control channels on each of the first and second uplink connections to the first network node and the second network node, or
to send the scheduling request to one of the first network node and the second network node according to a network configuration, or
to send the scheduling request to a selected network node of the first network node and the second network node, wherein the processor is configured to select the network node based on path loss measurements, or
to send the scheduling request to a network node having earliest scheduling request occurrence.

According to a second aspect of general embodiments of the present invention, an apparatus is provided comprising
a transceiver configured to be connectable to a user equipment an uplink connection and to be connectable to a another network node via an interface, the other network node being connectable to the same user equipment,
wherein the transceiver is configured to receive uplink control signalling dedicated for the apparatus via the uplink connection from the user equipment independently from the other network node.

The second aspect may be modified as follows:

The uplink connection may comprise at least one component carrier.

A physical uplink control channel or a physical uplink shared channel may be configured on the uplink connection.

The apparatus may further comprise a processor which is configured to decide whether the user equipment is able to perform transmission on the uplink connection to the apparatus and transmission on an uplink connection to the other network node, and to stop scheduling the user equipment in case it is decided that the user equipment is not able to perform both transmissions.

The processor may be configured to conduct the decision based on estimated power requirements of the user equipment.

According to a third aspect of general embodiments of the present invention, a system is provided which comprises a first network node and at least a second network node,
wherein the first network node is connectable to a user equipment by a first uplink connection and the at least second network node is connectable to the user by a second uplink connection,
wherein the first network node is configured to receive uplink control signalling via the first uplink connection, and the second network node is configured to receive uplink control signalling via the second uplink connection independently from each other.

The third aspect may be modified as follows:

The first uplink connection may comprise at least one component carrier, and the second uplink connection may comprise at least one component carrier.

On the first uplink connection a physical uplink control channel or a physical uplink shared channel may be configured and on the second uplink connection a physical uplink control channel or a physical uplink shared channel may be configured.

According to a fourth aspect of general embodiments of the present invention, a method is provided comprising
generating uplink control signalling independently for a first network node, which connectable by a first uplink connection, and a second network node, which is connectable by a second uplink connection, and
sending the generated uplink control signalling for the first network node via the first uplink connection, and the generated uplink control signalling for the second network node via the second uplink connection.

The fourth aspect may be modified as follows:

The first uplink connection may comprise at least one component carrier, and the second uplink connection comprises at least one component carrier.

On the first uplink connection a physical uplink control channel may be configured and on the second uplink connection a physical uplink control channel may be configured, and the method may further comprise sending the generated uplink control signalling via the physical uplink control channels on the first and the second uplink connections.

Alternatively, on the first uplink connection a physical uplink shared channel may be configured and on the second uplink connection a physical shared control channel may be configured, and the method may further comprise sending the generated uplink control signalling via the physical shared control channels on the first and the second uplink connections.

A physical uplink shared channel may be configured on one of the first and second uplink connections, and a physical uplink control channel may be configured on the other one of the first and second uplink connections, and the method may further comprise sending the generated uplink control signalling via the physical uplink shared channel on the corresponding one of the first and second uplink connections and the physical uplink shared channel on the corresponding other one of the first and second uplink connection.

The method may further comprise deciding sending the uplink control signalling only on one of the first uplink connection and the second uplink connection.

The method may further comprise basing the decision on power requirements of a user equipment in which the method is carried out.

The uplink control signalling may comprise a scheduling request, and the method may further comprise
sending the scheduling request on physical uplink control channels on each of the first and second uplink connections to the first network node and the second network node, or
sending the scheduling request to one of the first network node and the second network node according to a network configuration, or
sending the scheduling request to a selected network node of the first network node and the second network node, wherein the processor is configured to select the network node based on path loss measurements, or
to sending the scheduling request to a network node having earliest scheduling request occurrence.

According to a fifth aspect of general embodiments of the present invention, a method is provided comprising
receiving uplink control signalling via an uplink connection from a user equipment,
wherein the user equipment is connectable to another network node, and the uplink control signalling is dedicated for the connection between the user equipment and the network node carrying out the method.

The fifth aspect may be modified as follows:

The uplink connection may comprise at least one component carrier.

A physical uplink control channel or a physical uplink shared channel may be configured on the uplink connection.

The method may further comprise
deciding whether the user equipment is able to perform transmission on the uplink connection to the apparatus and transmission on an uplink connection to the other network node, and
stopping scheduling the user equipment in case it is decided that the user equipment is not able to perform both transmissions.

The decision may be based on estimated power requirements of the user equipment.

According to an sixth aspect of several embodiments of the present invention, a computer program product is provided which comprises code means for performing a method according to any one of the fourth and fifth aspects and their modifications when run on a processing means or module.

The computer program product may comprise a computer-readable medium on which the software code portions are stored, and/or wherein the program is directly loadable into a memory of the processor.

According to a seventh aspect of several embodiments of the invention, an apparatus is provided which comprises
means for generating uplink control signalling independently for a first network node, which connectable by a first uplink connection, and a second network node, which is connectable by a second uplink connection, and
means for sending the generated uplink control signalling for the first network node via the first uplink connection, and the generated uplink control signalling for the second network node via the second uplink connection.

According to a eighth aspect of several embodiments of the invention, an apparatus is provided which comprises
means for receiving uplink control signalling via an uplink connection from a user equipment,
wherein the user equipment is connectable to another network node, and the uplink control signalling is dedicated for the connection between the user equipment and the network node carrying out the method.

In the above aspects, the apparatus according to the first and seventh aspect may be a user equipment or a part thereof, and the apparatus according to the second and eighth aspect may be a network node, for example a base station such as a eNB, including PCell, SCell, macro-node and/or pico-node as described in the above embodiments.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. An apparatus comprising
a transceiver configured to be connectable to a first network node by a first uplink connection and at least a second network node by a second uplink connection, and
a processor configured to generate uplink control signalling independently for each network node,
wherein the transceiver is configured to send the generated uplink control signalling for the first network node via the first uplink connection, and the generated uplink control signalling for the second network node via the second uplink connection.

2. The apparatus according to claim 1,
wherein the first uplink connection comprises at least one component carrier, and the second uplink connection comprises at least one component carrier.

3. The apparatus according to claim 1, wherein
on the first uplink connection a physical uplink control channel is configured and on the second uplink connection a physical uplink control channel is configured, and the transceiver is configured to send the generated uplink control signalling via the physical uplink control channels on the first and the second uplink connections, or
on the first uplink connection a physical uplink shared channel is configured and on the second uplink connection a physical shared control channel is configured, and the transceiver is configured to send the generated uplink control signalling via the physical shared control channels on the first and the second uplink connections.

4. The apparatus according to claim 1, wherein
a physical uplink shared channel is configured on one of the first and second uplink connections, and a physical uplink control channel is configured on the other one of the first and second uplink connections, and the transceiver is configured to send the generated uplink control signalling via the physical uplink shared channel on the corresponding one of the first and second uplink connections and the physical uplink shared channel on the corresponding other one of the first and second uplink connection.

5. The apparatus according to claim 1, wherein the processor is configured to decide sending the uplink control signalling only on one of the first uplink connection and the second uplink connection.

6. The apparatus according to claim 5, wherein the processor is configured to base the decision on power requirements of the apparatus.

7. The apparatus according to claim 1, wherein the uplink control signalling comprises a scheduling request, and the processor is configured
to send the scheduling request on physical uplink control channels on each of the first and second uplink connections to the first network node and the second network node, or
to send the scheduling request to one of the first network node and the second network node according to a network configuration, or
to send the scheduling request to a selected network node of the first network node and the second network node, wherein the processor is configured to select the network node based on path loss measurements, or
to send the scheduling request to a network node having earliest scheduling request occurrence.

8. An apparatus comprising
a transceiver configured to be connectable to a user equipment an uplink connection and to be connectable to a another network node via an interface, the other network node being connectable to the same user equipment,
wherein the transceiver is configured to receive uplink control signalling dedicated for the apparatus via the uplink connection from the user equipment independently from the other network node.

9. The apparatus according to claim 8,
wherein the uplink connection comprises at least one component carrier.

10. The apparatus according to claim 8, wherein
a physical uplink control channel or a physical uplink shared channel is configured on the uplink connection.

11. The apparatus according to claim 8, further comprising a processor which is configured
to decide whether the user equipment is able to perform transmission on the uplink connection to the apparatus and transmission on an uplink connection to the other network node, and
to stop scheduling the user equipment in case it is decided that the user equipment is not able to perform both transmissions.

12. The apparatus according to claim 11, wherein the processor is configured to conduct the decision based on estimated power requirements of the user equipment.

13. A system comprising
a first network node and at least a second network node,
wherein the first network node is connectable to a user equipment by a first uplink connection and the at least second network node is connectable to the user by a second uplink connection,
wherein the first network node is configured to receive uplink control signalling via the first uplink connection, and the second network node is configured to receive uplink control signalling via the second uplink connection independently from each other.

14. The system according to claim 13, wherein
wherein the first uplink connection comprises at least one component carrier, and the second uplink connection comprises at least one component carrier.

15. The system according to claim 13, wherein
on the first uplink connection a physical uplink control channel or a physical uplink shared channel is configured and on the second uplink connection a physical uplink control channel or a physical uplink shared channel is configured.

16. AR A method comprising
generating uplink control signalling independently for a first network node, which connectable by a first uplink connection, and a second network node, which is connectable by a second uplink connection, and
sending the generated uplink control signalling for the first network node via the first uplink connection, and the generated uplink control signalling for the second network node via the second uplink connection.

17. The method according to claim 16,
wherein the first uplink connection comprises at least one component carrier, and the second uplink connection comprises at least one component carrier.

18. The method according to claim 16, wherein
on the first uplink connection a physical uplink control channel is configured and on the second uplink connection a physical uplink control channel is configured, and the method further comprises sending the generated uplink control signalling via the physical uplink control channels on the first and the second uplink connections, or
on the first uplink connection a physical uplink shared channel is configured and on the second uplink connection a physical shared control channel is configured, and the method further comprises sending the generated uplink control signalling via the physical shared control channels on the first and the second uplink connections.

19. The method according to claim 16, wherein
a physical uplink shared channel is configured on one of the first and second uplink connections, and a physical uplink control channel is configured on the other one of the first and second uplink connections, and the method further comprises sending the generated uplink control signalling via the physical uplink shared channel on the corresponding one of the first and second uplink connections and the physical uplink shared channel on the corresponding other one of the first and second uplink connection.

20. The method according to claim 16 further comprising deciding sending the uplink control signalling only on one of the first uplink connection and the second uplink connection.

21. The method according to claim 20, further comprising basing the decision on power requirements of a user equipment in which the method is carried out.

22. The method according to claim 16 wherein the uplink control signalling comprises a scheduling request, and the method further comprises
sending the scheduling request on physical uplink control channels on each of the first and second uplink connections to the first network node and the second network node, or
sending the scheduling request to one of the first network node and the second network node according to a network configuration, or
sending the scheduling request to a selected network node of the first network node and the second network node, wherein the processor is configured to select the network node based on path loss measurements, or
to sending the scheduling request to a network node having earliest scheduling request occurrence.,

23. A method comprising
receiving uplink control signalling via an uplink connection from a user equipment,
wherein the user equipment is connectable to another network node, and the uplink control signalling is dedicated for the connection between the user equipment and the network node carrying out the method.

24. The method according to claim 23,
wherein the uplink connection comprises at least one component carrier.

25. The method according to claim 23, wherein
a physical uplink control channel or a physical uplink shared channel is configured on the uplink connection.

26. The method according to claim 23, further comprising
deciding whether the user equipment is able to perform transmission on the uplink connection to the apparatus and transmission on an uplink connection to the other network node, and
stopping scheduling the user equipment in case it is decided that the user equipment is not able to perform both transmissions.

27. The method according to claim 26, wherein the decision is based on estimated power requirements of the user equipment.

28. A computer program product comprising code means for performing a method according to claim 16 when run on a processing means or module.

29. The computer program product according to claim 28, wherein the computer program product is embodied on a computer-readable medium.
